(19) United States
(12) Patent Application Publication
(10) Pub. No.: US 2013/0002811 A1
(43) Pub. Date: Jan. 3, 2013

(54) THREE-DIMENSIONAL IMAGING METHOD USING SINGLE-LENS IMAGE-CAPTURE APPARATUS AND THREE-DIMENSIONAL IMAGE ENHANCEMENT METHOD BASED ON TWO-DIMENSIONAL IMAGES

(76) Inventors: Lin-Kai Bu, Tainan City (TW); Chi-Chia Lin, Tainan City (TW)

(21) Appl. No.: 13/170,201

(22) Filed: Jun. 28, 2011

(51) Int. Cl. H04N 13/00; H04N 13/02

(52) U.S. Cl. 348/43; 348/50; 348/E13.074; 348/E13.002

(57) ABSTRACT

A three-dimensional (3D) imaging method using one single-lens image-capture apparatus, comprising: deriving a first two-dimensional (2D) image with the single-lens image-capture apparatus; deriving a depth map corresponding to the first 2D image; synthesizing a view synthesized image according to the depth map and the first 2D image; and deriving a second 2D image with the single-lens image-capture apparatus according to the view synthesized image, wherein the first 2D image and the second 2D image are utilized for 3D image display.

### BACKGROUND OF THE INVENTION

1. Field of the Invention

The present invention relates to a three-dimensional (3D) imaging method, and more particularly, to a three-dimensional (3D) imaging method using one single-lens image-capture apparatus.

2. Description of the Prior Art

Three-dimensional (3D) imaging has become a trend in the visual imaging industry. Most 3D imaging requires two image-capture apparatus to serve as, respectively, a left eye and a right eye. This means the two image-capture apparatus should be arranged at particular locations to derive images; otherwise the 3D visual effect may not be as vivid as expected. In other words, a conventional 3D imaging apparatus requires at least two lenses to properly derive the 3D imaging materials, and it is not possible to perform conventional 3D imaging with only one single-lens image-capture apparatus.

In addition, conventional 3D imaging also requires the two image-capture apparatus to capture images simultaneously. If the two image-capture apparatus do not operate at the same time, there may be a lack of coherence between the two captured images. For example, when taking a picture of a falling ball, if a first camera (which serves as the left eye) captures an image at a first timing and a second camera (which serves as the right eye) captures another image at a second timing afterwards, the position of the ball will be different in the two images, and as a result, a 3D imaging based on those two image will look incorrect.

### SUMMARY OF THE INVENTION

In light of the above, the present invention provides a three-dimensional (3D) imaging method which is capable of achieving 3D imaging using one single-lens image-capture apparatus. In addition, the present invention also provides a 3D image enhancement method based on two-dimensional (2D) images whether the 2D images are taken simultaneously or not.

In a first embodiment of the present invention, a three-dimensional (3D) imaging method using one single-lens image-capture apparatus is provided, wherein the 3D imaging method comprises: deriving a first two-dimensional (2D) image with the single-lens image-capture apparatus; deriving a depth map corresponding to the first 2D image; synthesizing a view synthesized image according to the depth map and the first 2D image; and deriving a second 2D image with the single-lens image-capture apparatus according to the view synthesized image, wherein the first 2D image and the second 2D image are utilized for 3D image display.

In a second embodiment of the present invention, a 3D image enhancement method based on a first two-dimensional (2D) image and a second 2D image for 3D image display is provided. The 3D image enhancement method comprises detecting a discrepancy between the first 2D image and the second 2D image; and modifying one of the first and the second 2D images according to the detected discrepancy.

In a second embodiment of the present invention, a 3D image enhancement apparatus based on a first 2D image and a second 2D image for 3D image display is provided. The 3D image enhancement apparatus comprises a detecting circuit and a modification circuit. The detecting circuit is for detecting a discrepancy between the first 2D image and the second 2D image. The modification circuit is for modifying one of the first and the second 2D images according to the detected discrepancy.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exemplary flowchart of a 3D imaging method using one single-lens image-capture apparatus according to an embodiment of the present invention.

FIG. 2 is an operational diagram of a 3D imaging method according to an embodiment of the present invention.

FIG. 3 is an operational diagram of a 3D imaging method according to another embodiment of the present invention.

FIG. 4 is an exemplary flowchart of a 3D image enhancement method based on a first 2D image and a second 2D image for 3D image display according to an embodiment of the present invention.

FIG. 5 is a block diagram of a 3D image enhancement apparatus based on a first 2D image and a second 2D image for 3D image display according to an embodiment of the present invention.

FIG. 6 is an operational diagram of an object insertion unit according to an embodiment of the present invention.

FIG. 7 is an operational diagram of an object removal unit according to an embodiment of the present invention.

### DETAILED DESCRIPTION

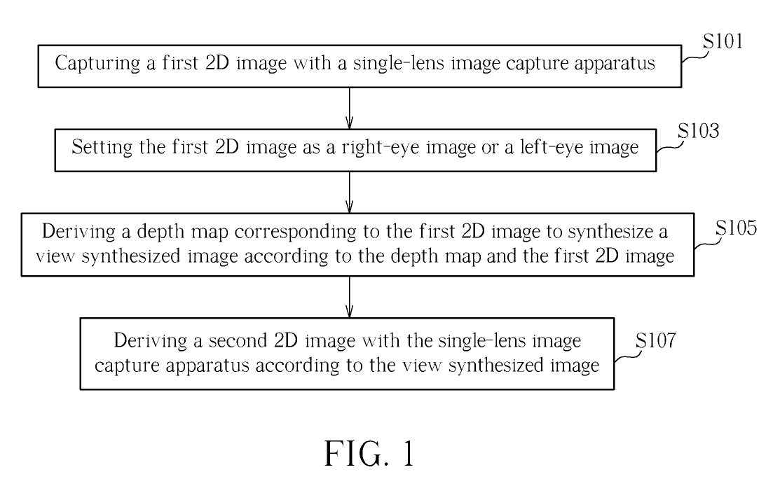

Please refer to FIG. 1, which is an exemplary flowchart of a three-dimensional (3D) imaging method using one single-lens image-capture apparatus according to an embodiment of the present invention. If the result is substantially the same, the steps are not required to be executed in the exact order shown in FIG. 1. In addition, the steps in FIG. 1 are not required to be executed sequentially, i.e., other steps can be inserted in between. The steps are detailed as follows:

S101: capturing a first two-dimensional (2D) image with a single-lens image-capture apparatus;

S103 setting the first 2D image as a right-eye image or a left-eye image;

S105: deriving a depth map corresponding to the first 2D image to synthesize a view synthesized image according to the depth map and the first 2D image; and

S107: deriving a second 2D image with the single-lens image-capture apparatus according to the view synthesized image.

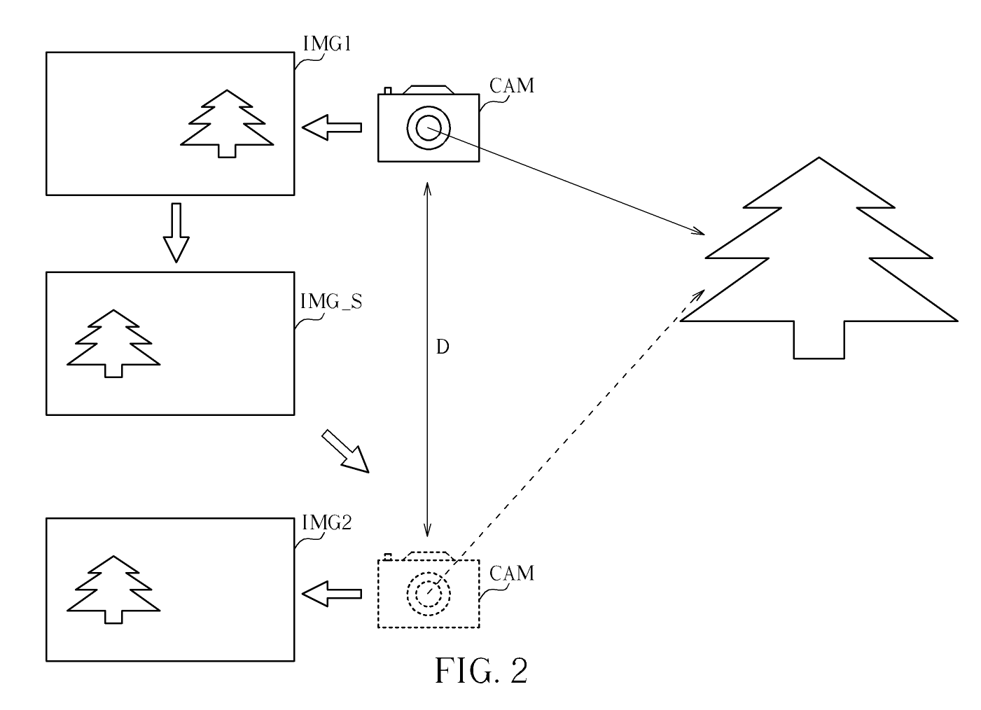

Please refer to FIG. 2 in conjunction with FIG. 1. FIG. 2 is an operational diagram of the 3D imaging method according to an embodiment of the present invention. In step S101, a single-lens image-capture apparatus CAM is utilized to capture a first 2D image IMG1. Next in step S103, the first 2D image IMG2 is set as a right-eye image or a left-eye image, and a distance of the other image is also configured. In the example of FIG. 2, the first 2D image IMG1 is taken at a first spot to serve as the left-eye image, and the distance D of a second spot (where the right-eye image is taken at) from the first spot should be determined in this step. In step S105, a depth map corresponding to the first 2D image IMG1 is derived, and a view synthesized image IMG_S is thereby synthesized according to the depth map and the first 2D image IMG1. In step S107, a user may refer to the distance D and the view synthesized image IMG_S to find the second spot; for example, the user may utilize the single-lens image-capture apparatus CAM to check with the view synthesized image IMG_S at a distance D away from the first spot. When the view seen via the single-lens image-capture apparatus CAM is almost identical to the view synthesized image IMG_S, the single-lens image-capture apparatus CAM will notify the user it is the right spot to capture the second 2D image IMG2, i.e., with the help of the view synthesized image IMG_S, the user is able to find the correct second spot to derive the second 2D image IMG2 with the single-lens image-capture apparatus CAM. In this way, the first 2D image IMG1 and the second 2D image IMG2 can be derived to be utilized for 3D image display.

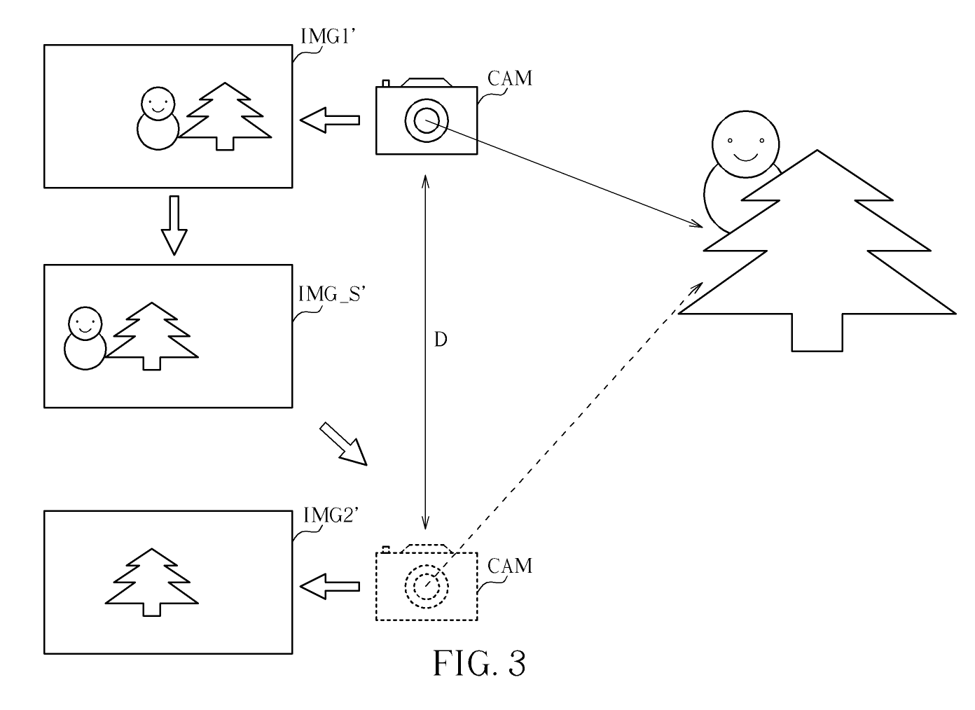

Please refer to FIG. 3 for another practical example of the present invention. FIG. 3 is an operational diagram of the 3D imaging method according to another embodiment of the present invention. Compared with FIG. 2, an additional object OBJ (in this case, the object OBJ is a snowman standing besides the tree which is originally in FIG. 2) is presented. A first 2D image IMG1′ is taken from the first spot, and an image of the object OBJ is thereby presented in the first 2D image IMG1′, therefore the view synthesized image IMS_S′ also has a corresponding image of the object OBJ; however, in a second 2D image IMG2′ taken at the second spot, the object OBJ is blocked and thus the image of the object OBJ does not appear in the second 2D image IMG2′. Since there is inconsistency between the first 2D image IMG1′ and the second 2D image IMG2′, i.e., the object OBJ, when utilizing the first 2D image IMG1′ and the second 2D image IMG2′ for 3D display, there will be a certain visual discrepancy.

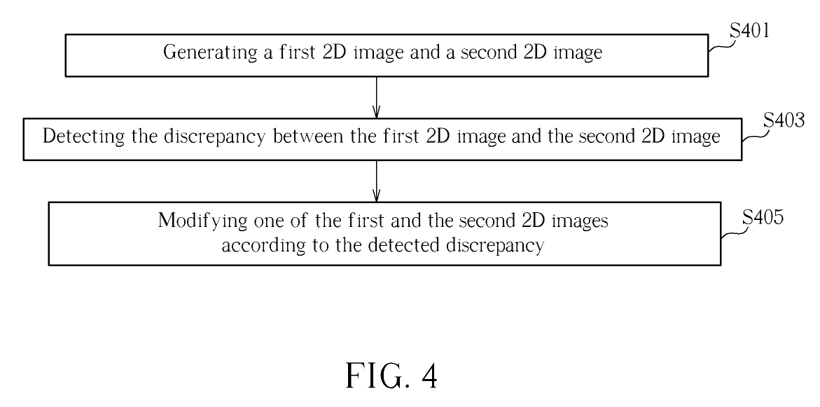

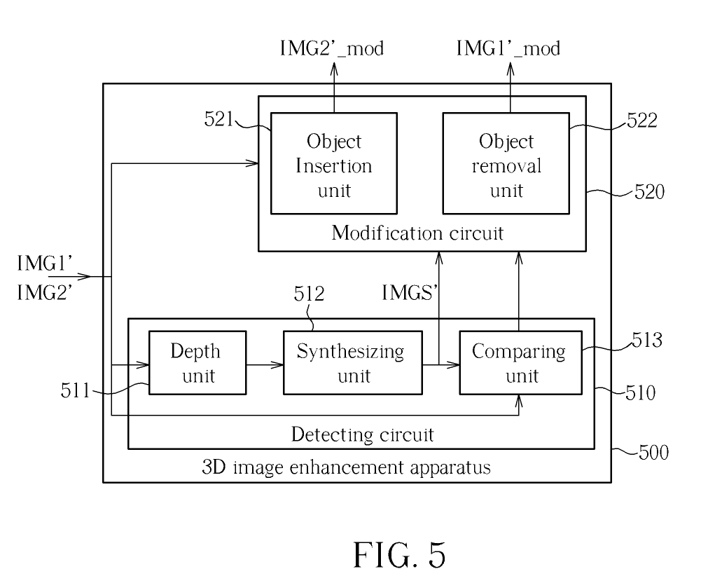

To solve the above-identified issue, please refer to FIG. 4 in conjunction with FIG. 5. FIG. 4 is an exemplary flowchart of a 3D image enhancement method based on a first 2D image and a second 2D image for 3D image display according to an embodiment of the present invention, and FIG. 5 is a block diagram of a 3D image enhancement apparatus 500 based on a first 2D image and a second 2D image for 3D image display according to an embodiment of the present invention. If the result is substantially the same, the steps are not required to be executed in the exact order shown in FIG. 4. In addition, the steps in FIG. 4 are not required to be executed sequentially, i.e., other steps can be inserted in between. The steps are detailed as follows:

S401: generating a first 2D image and a second 2D image;

S403: detecting a discrepancy between a first 2D image and a second 2D image; and

S405: modifying one of the first and the second 2D images according to the detected discrepancy.

In step S401, the first 2D image IMG1′ and the second 2D image IMG2′ are generated by the single-lens image-capture apparatus CAM at the first spot and the second spot, respectively, and both images are outputted to the 3D image enhancement apparatus 500. The 3D image enhancement apparatus 500 includes a detecting circuit 510 and a modification circuit 520. The detecting circuit 510 detects a discrepancy between the first 2D image IMG1′ and the second 2D image IMG2′. In step S403, the detecting circuit 510 processes the first 2D image IMG1′ and the second 2D image IMG2′ to derive a discrepancy between the first 2D image IMG1′ and the second 2D image IMG2′. In this embodiment, the detecting circuit 510 includes a depth unit 511, a synthesizing unit 512 and a comparing unit 513. The depth unit 511 derives a depth map corresponding to the first 2D image IMG1′. The synthesizing unit 512 derives the synthesized view image IMGS1′ according to the depth map and the first 2D image IMG1′. The comparing unit 513 compares the synthesized view image IMGS′ with the second 2D image IMG2′ to derive the discrepancy. In this case, the discrepancy is the object OBJ. As shown in FIG. 3, the object OBJ is shown in the first 2D image IMG1′ as well as the synthesized view image IMG_S′, but it is absent in the second 2D image IMG2′. It should be obvious that the major difference between the synthesized view image IMG_S′ and the second 2D image IMG2′ is the image of the object OBJ, therefore the object OBJ is successively detected as the discrepancy.

Next, in the step 5405, one of the first and the second 2D images is selected to be modified according to the detected discrepancy by the modification circuit 520. To achieve this goal, it is optional to eliminate the image corresponding to the object OBJ in the first 2D image IMG1′ or to add the image corresponding to the object OBJ in the second 2D image IMG2′. The modification circuit 520 includes an object insertion unit 521 and an object removal unit 522 for different operations. The object insertion unit 521 is for deriving an object image corresponding to the identified object OBJ from the view synthesized image IMGS′ and modifying the second 2D image IMS2′ with the object image, and the object removal unit 522 is for removing the object image corresponding to the identified object OBJ from the first 2D image. The modification circuit 520 in FIG. 5 is merely a preferred embodiment; the modification circuit in the other embodiments may contain only one of the object insertion and the object removal functions, and this kind of variation in design also falls within the scope of the present invention.

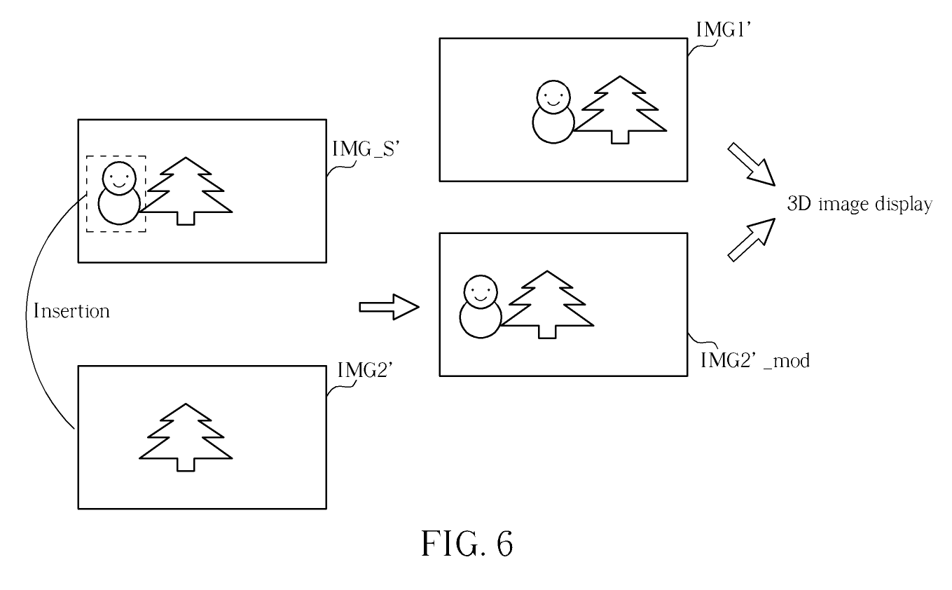

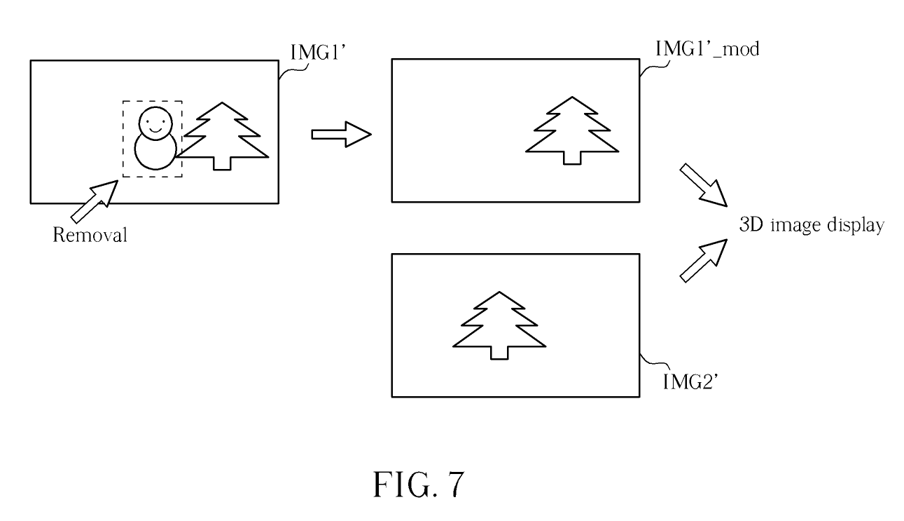

Please refer to FIG. 6 for further operation details of the 3D image enhancement method of the present invention; FIG. 6 is an operational diagram of the object insertion unit 521 according to an embodiment of the present invention. When the user chooses to add the image of the object OBJ in the second 2D image IMG2′, the object insertion unit 521 will derive the object image corresponding to the identified object OBJ (the snowman within the dashed-line square in FIG. 6), and insert the object image into the second 2D image IMG2′ to generate a modified second 2D image IMG2′_mod. The modified second 2D image IMG2′_mod is therefore utilized for 3D image display in conjunction with the first 2D image IMG1′. FIG. 7 is an operational diagram of the object removal unit 522 according to an embodiment of the present invention. When the user chooses to eliminate the image of the object OBJ in the first 2D image IMG1′, the object removal unit 522 will simply remove the image of the object OBJ from the first 2D image IMG1′ to generate a modified 2D image IMG1′_mod. The modified first 2D image IMG1′_mod is therefore utilized for 3D image display in conjunction with the second 2D image IMG2′. In this way, no matter whether the user chooses to insert or remove the discrepancy, the outcome of the 3D image display will be more natural to human vision.

To summarize, the present invention provides a 3D imaging method capable of achieving 3D imaging using one single-lens image-capture apparatus. In addition, the present invention also provides a 3D image enhancement method based on 2D images and a related 3D image enhancement apparatus. With the help of the 3D image enhancement method of the present invention, the discrepancy between the two 2D images is compensated and a 3D image display of better quality is achieved.

Those skilled in the art will readily observe that numerous modifications and alterations of the device and method may be made while retaining the teachings of the invention.

What is claimed is:

1. A three-dimensional (3D) imaging method using one single-lens image-capture apparatus, comprising:
deriving a first two-dimensional (2D) image with the single-lens image-capture apparatus;
deriving a depth map corresponding to the first 2D image;
synthesizing a view synthesized image according to the depth map and the first 2D image; and
deriving a second 2D image with the single-lens image-capture apparatus according to the view synthesized image, wherein the first 2D image and the second 2D image are utilized for 3D image display.

2. The 3D imaging method of claim 1, wherein the first 2D image is derived with the single-lens image-capture apparatus at a first spot; and the step of deriving the second 2D image with the single-lens image-capture apparatus according to the view synthesized image comprises:
deriving a second spot different from the first spot according to the view synthesized image; and
deriving the second 2D image with the single-lens image-capture apparatus at the second spot.

3. The 3D imaging method of claim 1, further comprising:
identifying an object according to the depth map, wherein the object is fully shown in one of the first 2D image and the second 2D image, but partially shown in the other of the first 2D image and the second 2D image; and
compensating one of the first 2D image and the second 2D image according to the identified object and the view synthesized image.

4. The 3D imaging method of claim 3, wherein the step of compensating one of the first 2D image and the second 2D image according to the object and the view synthesized image comprises:
deriving an object image corresponding to the identified object from the view synthesized image; and
modifying the second 2D image with the object image.

5. The 3D imaging method of claim 3, wherein the step of compensating one of the first 2D image and the second 2D image according to the object and the view synthesized image comprises:
removing an object image corresponding to the identified object from the first 2D image.

6. A three-dimensional (3D) image enhancement method based on a first two-dimensional (2D) image and a second 2D image for 3D image display, comprising:
detecting a discrepancy between the first 2D image and the second 2D image; and
modifying one of the first and the second 2D images according to the detected discrepancy.

7. The 3D image enhancement method of claim 6, wherein the step of detecting the discrepancy between the first 2D image and the second 2D image comprises:
deriving a depth map corresponding to the first 2D image;
deriving a synthesized view image according to the depth map and the first 2D image; and
comparing the synthesized view image with the second 2D image to derive the discrepancy.

8. The 3D image enhancement method of claim 7, wherein the step of comparing the synthesized view image with the second 2D image to derive the discrepancy comprises:
deriving the discrepancy from identifying an object according to the depth map, wherein the object is fully shown in one of the first 2D image and the second 2D image, but partially shown or absent in the other of the first 2D image and the second 2D image.

9. The 3D image enhancement method of claim 8, wherein the step of modifying one of the first and the second 2D images according to the discrepancy comprises:
deriving an object image corresponding to the identified object from the view synthesized image; and
modifying the second 2D image with the object image.

10. The 3D image enhancement method of claim 7, wherein the step of modifying one of the first and the second 2D images according to the discrepancy comprises:
removing an object image corresponding to the identified object from the first 2D image.

11. A three-dimensional (3D) image enhancement apparatus based on a first two-dimensional (2D) image and a second 2D image for 3D image display, comprising:
a detecting circuit, for detecting a discrepancy between the first 2D image and the second 2D image; and
a modification circuit, coupled to the detecting unit, for modifying one of the first and the second 2D images according to the detected discrepancy.

12. The 3D image enhancement apparatus of claim 11, wherein the detecting circuit comprises:
a depth unit, for deriving a depth map corresponding to the first 2D image;
a synthesizing unit, coupled to the depth unit, for deriving a synthesized view image according to the depth map and the first 2D image; and
a comparing unit, coupled to the synthesizing unit, for comparing the synthesized view image with the second 2D image to derive the discrepancy.

13. The 3D image enhancement apparatus of claim 12, wherein the comparing unit derives the discrepancy from identifying an object according to the depth map, wherein the object is fully shown in one of the first 2D image and the second 2D image, but partially shown in the other of the first 2D image and the second 2D image.

14. The 3D image enhancement apparatus of claim 13, wherein the modification circuit comprises:
an object insertion unit, for deriving an object image corresponding to the identified object from the view synthesized image and modifying the second 2D image with the object image.

15. The 3D image enhancement apparatus of claim 13, wherein the modification circuit comprises:
an object removal unit, for removing an object image corresponding to the identified object from the first 2D image.
